(19) United States
(12) Patent Application Publication
(10) Pub. No.: US 2026/0147927 A1
(43) Pub. Date: May 28, 2026

(54) OBSCURED FILES IN AN UPPER FILESYSTEM LAYER

(71) Applicant: HEWLETT PACKARD ENTERPRISE DEVELOPMENT LP, Spring, TX (US)

(72) Inventor: Aseem Sethi, Bangalore (IN)

(21) Appl. No.: 19/065,554

(22) Filed: Feb. 27, 2025

(30) Foreign Application Priority Data
Nov. 26, 2024 (IN) 202441092523

(51) Int. Cl. G06F 21/62

(52) U.S. Cl. CPC G06F 21/6254; G06F 21/6209

(57) ABSTRACT

In some examples, a base filesystem layer stores a file. As part of provisioning a computer system, the computer system creates an upper filesystem layer that overlays the base filesystem layer, obscures the file to render at least a portion of the file inaccessible, and adds the obscured file to the upper filesystem layer. Responsive to an access request from a process targeting the file, the upper filesystem layer returns the obscured file to the process.

### BACKGROUND

A computer system can execute various processes that can access data stored in a storage system. A filesystem can be implemented to manage the organization and access of the data in the storage system. The filesystem organizes the data as files in various directories.

### BRIEF DESCRIPTION OF THE DRAWINGS

Some implementations of the present disclosure are described with respect to the following figures.

FIG. 1 is a block diagram of a computer system according to some examples.

FIG. 2 is a flow diagram of a flow according to some examples.

FIG. 3 is a block diagram of a storage medium storing machine-readable instructions according to some examples.

FIG. 4 is a block diagram of a computer system according to further examples.

FIG. 5 is a flow diagram of a flow according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Data of a storage system accessible by processes in a computer system may include sensitive data, such as personally identifiable information (PII) data, proprietary data of an enterprise, or other types of data that is to be protected against access by unauthorized entities (humans, programs, or machines). PII data includes data that may potentially identify a property associated with a person, a program, or a machine. Examples of PII data can include any or some combination of the following: data that indicates properties of an operating system (OS); data relating to a configuration of a machine; a network routing information for a computer system, such as a network address (e.g., an Internet Protocol (IP) address or a Media Access Control (MAC) address), port information (e.g., Transmission Control Protocol (TCP) port information or User Datagram Protocol (UDP) port information); user settings; credentials (e.g., passwords, certificates, etc.); geolocation information; and so forth. Proprietary data of an enterprise can include financial data, product development data, payroll data, and so forth.

Various techniques to protect access to sensitive data may be inadequate or may be complex. Some techniques may define, for each process, the types of system calls that the process may invoke (while other system calls to access data are blocked) to protect against access of sensitive data. Such techniques involve manual configuration by a human administrator, which is time consuming and labor intensive. Further techniques can define configuration policies for respective processes, where a configuration policy can filter which system calls by processes are allowed. Setting up configuration policies to protect sensitive data may be complex. Other techniques can use namespaces associated with processes to control access to sensitive data. However, use of namespaces may protect against access to some sensitive data but not to other sensitive data. Additional techniques to protect against access to sensitive data may involve context switching between a user space and a kernel space, which is processing and memory intensive.

In accordance with some implementations of the present disclosure, a data protection mechanism uses a layered filesystem to protect sensitive data against unauthorized or unintended access. The layered filesystem includes a base filesystem layer that stores data files (or more simply “files”), some of which contain sensitive data. The layered filesystem further includes an upper filesystem layer that overlays the base filesystem layer. As part of provisioning a computer system, the data protection mechanism creates an upper filesystem layer for a collection of files. The data protection mechanism obscures the files of the collection so that at least portions of the files are inaccessible. Obscuring a file can refer to anonymizing the file or pseudonymizing the file, or otherwise rendering at least a portion of the file indecipherable. When a process later issues an access request for any file in the collection, the access request is handled at the upper filesystem layer. The upper filesystem layer returns the obscured file that is the target of the access request to the process. The process can be a process executed at a virtual compute entity, such as a container or a virtual machine. The process may alternatively be a user space process not executed in a virtual computing environment.

In accordance with some examples of the present disclosure, computer functionality is improved by protecting sensitive data from unauthorized access, to prevent damage to the computer system or an enterprise operating the computer system. Protection is also provided against access and use of sensitive data that may be leveraged by malware to cause a disruption of the computer system. The protection of sensitive data can be achieved using a data protection mechanism that effectively provides a firewall against unauthorized access and that is not complex to implement since creation of upper filesystem layers of layered filesystems is relatively straightforward.

Anonymizing sensitive data in a file can include removing the sensitive data or otherwise rendering the sensitive data unrecoverable. Pseudonymizing sensitive data in a file can refer to replacing the sensitive data with a pseudonym (data with no real meaning) in the file.

A base filesystem layer refers to a filesystem associated with an operating system (OS), such as a Linux OS or another type of OS. A filesystem is used to organize data in files stored in a hierarchy of directories.

An upper filesystem layer refers to a separate filesystem layer that overlays the base filesystem layer. The upper filesystem layer presents a subset of files and directories that are present in the base filesystem layer. The upper filesystem layer can also be referred to as an overlay filesystem layer. In an example, the upper filesystem layer can present a directory tree (including a hierarchical arrangement of directories and files in the directories) that is also present in the base filesystem layer. The directory tree in the upper filesystem layer is a subset of the directory structure present in the base filesystem layer.

The combination of the base filesystem layer and an upper filesystem layer (that overlays the base filesystem layer) forms a layered filesystem, such as the Linux layered filesystem. Other types of layered filesystems may be a Unionfs filesystem, an advanced multi-layered unification filesystem (AUFS), or any other type of layered filesystem.

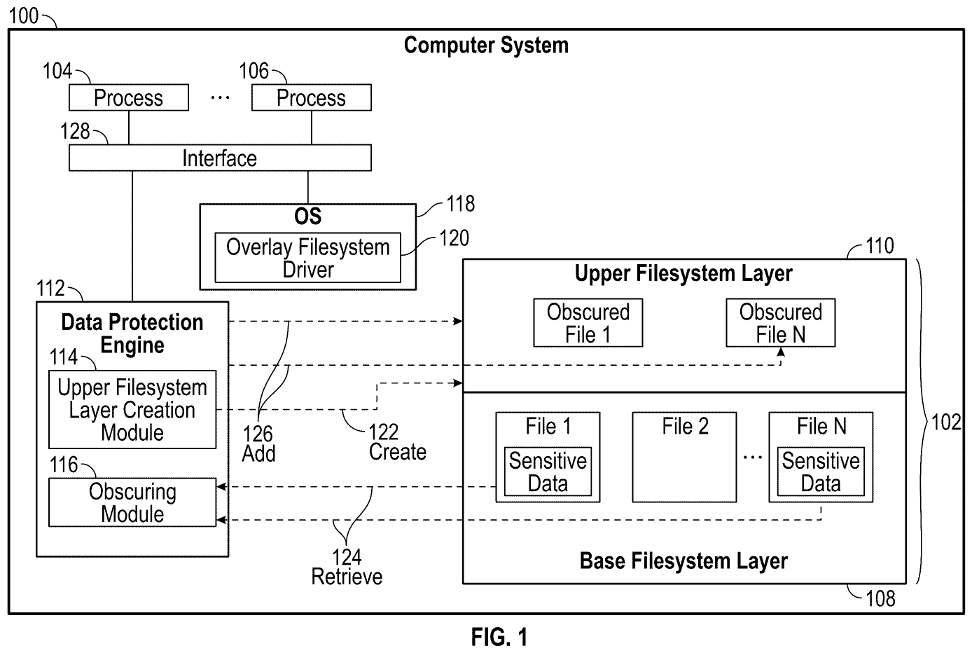

FIG. 1 is a block diagram of a computer system 100 that includes a layered filesystem 102 and processes 104, 106 that are able to access files of the layered filesystem 102. The computer system 100 can be implemented using one or more computers. Although two processes are shown in FIG. 1, in other examples, the computer system 100 can include just one process or more than two processes. A process can be a user space process or a process executed at a virtual compute entity such as the VM or container.

The layered filesystem 102 includes a base filesystem layer 108 and an upper filesystem layer 110. Although just one upper filesystem layer 110 is shown in FIG. 1, in other examples, multiple upper filesystem layers may overlay the base filesystem layer 108 in the layered filesystem 102.

The computer system 100 includes a data protection engine 112 that has an upper filesystem layer creation module 114 and an obscuring module 116. The data protection engine 112 is used to protect certain data in files of the base filesystem layer 108 against access by unauthorized processes, such as processes of malware or other entities not authorized to access the data. In some examples, the data protected by the data protection engine 112 includes sensitive data. The base filesystem layer 108 stores files 1 to N (N≥1), where at least some of the files contain sensitive data. In FIG. 1, file 1 contains sensitive data and file N contains sensitive data. File 2 does not contain sensitive data.

The data protection engine 112 can be implemented in the user space of the computer system 100. Alternatively, the data protection engine 112 can be implemented in a kernel space of the OS 118 of the computer system 100. In further examples, a portion of the data protection engine 112 can be implemented in the user space, while another portion of the data protection engine 112 can be implemented in the kernel space. The kernel space is a portion of a memory address space reserved for running privileged portions (e.g., the kernel) of the OS 118, while the user space is another portion of the memory address space where other programs, such as application programs, can execute.

During provisioning of the computer system 100, the upper filesystem layer creation module 114 creates (at 122) the upper filesystem layer 110 to overlay the base filesystem layer 108. Creating the upper filesystem layer 110 includes mounting the upper filesystem layer 110 so that an overlay filesystem driver 120 of the OS 118 first checks if a requested file is in the upper filesystem layer 110, and if so, the overlay filesystem driver 120 returns the requested file from the upper filesystem layer 110. If the requested file is not in the upper filesystem layer 110, the overlay filesystem driver 120 accesses the requested file in the base filesystem layer 108.

The overlay filesystem driver 120 is an entity in the OS 118 that is responsible for managing the access of the layered filesystem 102, and more specifically, for managing the access of files in a hierarchy of directories in the layered filesystem 102.

Provisioning a computer system can refer to initially setting up the computer system, which includes installing firmware and the OS 118. In further examples, provisioning the computer system can additionally refer to changing a configuration of the computer system after the initial setup, such as to perform maintenance or repair.

The data protection engine 112 retrieves (at 124) each file of the base filesystem layer 108 that is to be protected. In some examples, a file is to be protected if the file contains sensitive data, such as files 1 and N. The obscuring module 116 in the data protection engine 112 obscures each file that is to be protected. Obscuring a file can refer to obscuring the entire content of the file, or obscuring a portion (less than the entire content) of the file. Obscuring the file involves rendering at least a portion of the file indecipherable, such as by anonymizing or pseudonymizing at least the portion of the file. Anonymizing sensitive data in a file can include removing the sensitive data. In some cases, the entire content of the file may be removed so that the anonymized file includes empty content. In other cases, just certain parts of the file are anonymized by removing the content (with sensitive data) in the parts, while other parts of the file (without sensitive data) are not anonymized. Pseudonymizing sensitive data in a file can refer to replacing the sensitive data with a pseudonym (data with no real meaning) in the file. A process that is provided with the anonymized file or pseudonymized file would not be able to recover the sensitive data that has been removed or replaced. Other techniques of obscuring a file can include encrypting the file, or replacing the file with a shell file that does not contain any meaningful content. Encrypting a file can refer to encrypting a portion (less than the entirety) or the entirety of the file.

In the example of FIG. 1, the files obscured are files 1 and N. The data protection engine 112 adds (at 126) obscured files 1 and N to the upper filesystem layer 110. Adding an obscured file to the upper filesystem layer 110 is achieved by writing the obscured file to the upper filesystem layer 110.

Obscured file 1 in the upper filesystem layer 110 and file 1 in the base filesystem layer 108 share the same file identifier, such as a pathname that includes the filename of file 1 and the directory or directories that file 1 is (are) part of. Similarly, obscured file N in the upper filesystem layer 110 and file N in the base filesystem layer 108 share the same identifier. A file (or a directory) with the same file identifier that appears in both the upper filesystem layer 110 and the base filesystem layer 108 is retrieved from the upper filesystem layer 110 and not from the base filesystem layer 108. Effectively, the file with the same identifier in the base filesystem layer 108 is hidden from processes in the computer system 100, including the processes 104, 106.

By adding the obscured files 1 and N to the upper filesystem layer 110, any file access targeting a given file identifier that is present in the upper filesystem layer 110 will cause the identified obscured file to be retrieved by the overlay filesystem driver 120 from the upper filesystem layer 110. The overlay filesystem driver 120 would not access the non-obscured file identified by the given file identifier from the base filesystem layer 108, so that the non-obscured file (which may contain sensitive data) is not exposed. When a process receives an obscured file, the process would be unable to recover the content that was obscured.

In some examples, when certain processes (e.g., 104 and 106) are started in the computer system 100, each such process is configured with access to the layered filesystem 102. A process configured with access to the layered filesystem 102 is one without privileges to access sensitive data. For example, an OS 118 in the computer system 100 can provide, to the process, information of the layered filesystem 102 so that the process can issue access requests to the layered filesystem 102. Due to the presence of the upper filesystem layer 110 in the layered filesystem 102, any access request from the process to access a file (identified by a file identifier) in the layered filesystem 102 is handled by the overlay filesystem driver 120 in the OS 118 by first checking if the file is present in the upper filesystem layer 110. If so, the access request is satisfied by returning the file from the upper filesystem layer 110, i.e., the base filesystem layer 102 is not accessed so that effectively the file with the same file identifier in the base filesystem layer 102 is effectively hidden from the requesting process if the requested file is present in the upper filesystem layer 110. However, if the requested file is not present in the upper filesystem layer 102, then the overlay filesystem driver 120 accesses the requested file from the base filesystem layer 108.

Other processes with elevated privileges to access sensitive data (e.g., processes associated with programs used by users in selected departments of an enterprise) may be configured to access files directly from the base filesystem layer 108. Another filesystem driver (not shown) in the OS 118 can handle requests from processes with the elevated privileges to access files (which may contain sensitive data) from the base filesystem layer 108 (effectively bypassing the upper filesystem layer 110 that contains obscured files).

In examples where multiple upper filesystem layers are created to overlay the base filesystem layer 108, the multiple upper filesystem layers may be associated with respective collections of processes. Access requests from a first collection of processes can be directed by the overlay filesystem driver 120 to a first upper filesystem layer (which includes a first collection of obscured files), access requests from a second collection of processes can be directed by the overlay filesystem driver 120 to a second upper filesystem layer (which includes a first collection of obscured files), and so forth. As used here, a “collection” of items can refer to a single item or multiple items. Thus, a collection of processes can refer to a single process or multiple processes, and a collection of files can refer to a single file or multiple files.

The processes 104, 106 can issue file access requests to an interface 128. The interface 128 can include any of the following types of interfaces: a system call interface, a /proc interface, and a /sys interface. The system call interface includes a set of functions that can be invoked by processes using system calls. The system call interface is an interface between user space processes (e.g., 104 and 106) and the OS 118. A system call can be sent by a process to read or write files. For example, system calls can be issued to obtain a process identifier of a process, a host name, system information, or any other sensitive data.

A /proc interface is used by a kernel of the OS 118 to communicate information between the user space (including the processes 104, 106) and the OS kernel. The /sys interface is another type of interface from the user space to the OS kernel. The processes 104, 106 can issue read or write requests through the /proc interface or /sys interface. In other examples, the interface 128 can be implemented using another type of interface to allow a process to access files in a filesystem provided by the OS 118.

Assuming that the processes 104, 106 are configured with access to the layered filesystem 102, the overlay filesystem driver 120 responds to an access request from either process 104 or 106 received through the interface 128 by first determining if the requested file is in the upper filesystem layer 110, and if so, the requested file (an obscured file) is returned by the overlay filesystem driver 120 to the requesting process. If the requested file is not in the upper filesystem layer 110, the overlay filesystem driver 120 retrieves the file from the base filesystem layer 108. Another process (not shown) with elevated privileges may be configured by the OS 118 to access the base filesystem layer 108 directly, so that the other process may be able to obtain non-obscured files.

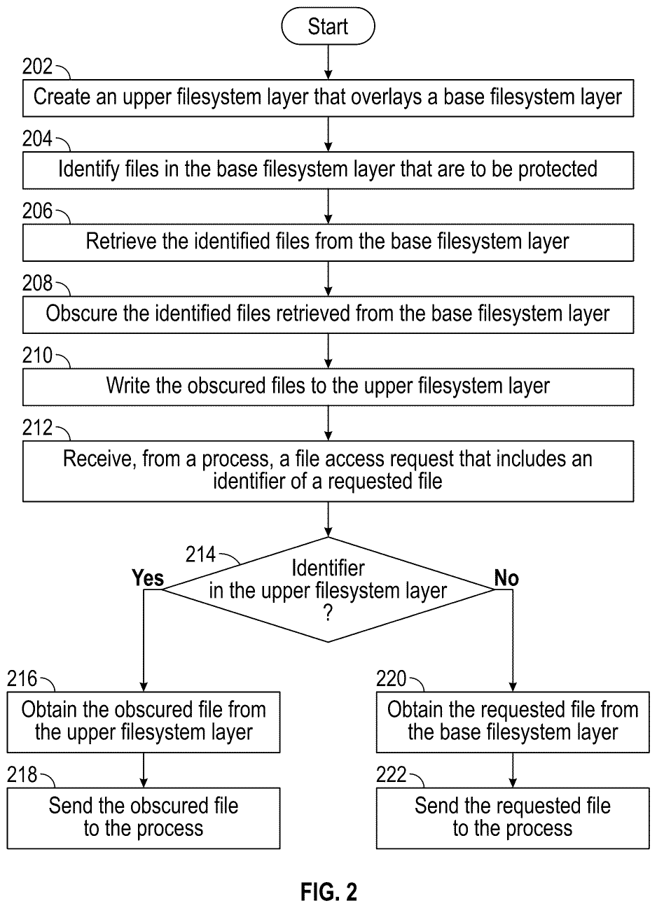

FIG. 2 is a flow diagram of a flow for protecting files. During provisioning of the computer system 100, the data protection engine 112 is invoked, such as by a user, a program, or a machine. The upper filesystem layer creation module 114 of the data protection engine 112 creates (at 202) the upper filesystem layer 110 that overlays the base filesystem layer 108.

The data protection engine 112 identifies (at 204) files in the base filesystem layer 108 that are to be protected. This identification can be based on configuration information provided to the data protection engine 112, where the configuration information lists files that are to be protected, such as files containing sensitive data.

The data protection engine 112 retrieves (at 206) the identified files from the base filesystem layer 108. The retrieval of the identified files can be accomplished by issuing read requests, such as via the interface 128. Since the identified files are not yet in the upper filesystem layer 110, the overlay filesystem driver 120 obtains the identified files from the base filesystem layer 108, and returns the identified files to the data protection engine 112.

The obscuring module 116 in the data protection engine 112 obscures (at 208) the identified files retrieved from the base filesystem layer 108. The data protection engine 112 writes (at 210) the obscured files to the upper filesystem layer 110. For example, the obscured files include obscured files 1 and N.

Subsequently, a process (e.g., 104 or 106) issues a file access request (read request or write request) to access a requested file. The file access request is issued to the interface 128. The overlay filesystem driver 120 receives (at 212), from the process, the file access request, which includes an identifier of the requested file. The overlay filesystem driver 120 determines (at 214) whether the identifier of the requested file is present in the upper filesystem layer 110. For example, an identifier of file 1 or N is present in the upper filesystem layer 110. In response to determining (at 214) that the identifier of the requested file is present in the upper filesystem layer 110, the overlay filesystem driver 120 obtains (at 216) the obscured file (e.g., obscured file 1 or N) from the upper filesystem layer 110, and sends (at 218) the obscured file to the process.

However, if the overlay filesystem driver 120 determines (at 214) that the identifier of the requested file (e.g., file 2) is not present in the upper filesystem layer 110, the overlay filesystem driver 120 obtains (at 220) the requested file (e.g., file 2) from the base filesystem layer 108, and sends (at 222) the requested file to the process.

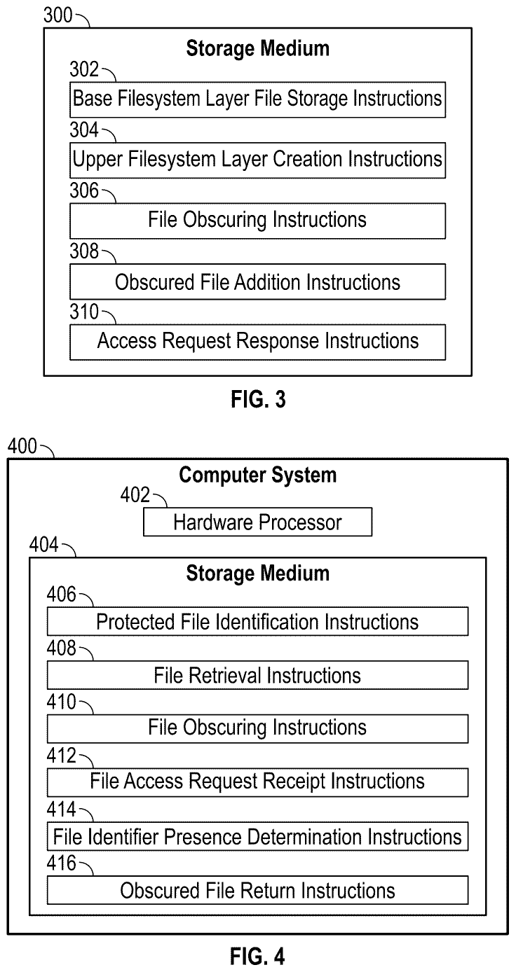

FIG. 3 is a block diagram of a non-transitory machine-readable or computer-readable storage medium 300 storing machine-readable instructions that upon execution cause a computer system to perform various tasks.

The machine-readable instructions include base filesystem layer file storage instructions 302 to store, by a base filesystem layer, a file. The file can include sensitive data to be protected against unauthorized access.

The machine-readable instructions include upper filesystem layer creation instructions 304 to create an upper filesystem layer that overlays the base filesystem layer. The upper filesystem layer is to be used for storing files to be protected against unauthorized access.

The machine-readable instructions include file obscuring instructions 306 to obscure the file to render at least a portion of the file inaccessible. The obscuring can include anonymizing or pseudonymizing at least the portion of the file, for example. Other ways of obscuring can include encrypting the file or replacing the file with a shell file. In examples where less than an entirety of the file is obscured, a first portion of the file can be obscured, while a second portion of the file remains unobscured.

The machine-readable instructions include obscured file addition instructions 308 to add the obscured file to the upper filesystem layer. The upper filesystem layer creation instructions 304, the file obscuring instructions 306, and the obscured file addition instructions 308 can be performed as part of provisioning the computer system.

The machine-readable instructions include access request response instructions 310 to, responsive to an access request from a process targeting the file, return, from the upper filesystem layer, the obscured file to the process. In some examples, an overlay filesystem driver (e.g., 120 in FIG. 1) of an OS can determine, in response to the access request, whether the targeted file is in the upper filesystem layer. If so, the targeted file is retrieved from the upper filesystem layer. If not, the targeted file is retrieved from the base filesystem layer.

In some examples, the file in the base filesystem layer is inaccessible to (hidden from) the process if the file is present in the upper filesystem layer.

In some examples, the file is part of a plurality of files stored by the base filesystem layer. The machine-readable instructions can obscure the plurality of files and add the obscured plurality of files to the upper filesystem layer. The obscured plurality of files is accessible to the process.

In some examples, the access request comprises a system call from the process.

In some examples, the access request is received through a /proc interface or a /sys interface.

In some examples, the base filesystem layer and the upper filesystem layer form a layered filesystem, and an identifier of the file is present in both the base filesystem layer and the upper filesystem layer.

In some examples, when starting the process in the computer system, the machine-readable instructions can configure the process to use the layered filesystem. The process is provided with information of the layered filesystem so that the process can issue access requests to the layered filesystem.

In some examples, the process is a user space process or is executed at a virtual compute entity (e.g., a container or a VM) in the computer system.

FIG. 4 is a block diagram of a computer system 400 according to some examples. The computer system 400 is an example of the computer system 100 of FIG. 1.

The computer system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The computer system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include protected file identification instructions 406 to identify a file, in a base filesystem layer, to be protected from unauthorized access. Such a file may be a file containing sensitive data.

The machine-readable instructions in the storage medium 404 include file retrieval instructions 408 to retrieve the file from the base filesystem layer. The retrieval request can be issued to the interface 128 of FIG. 1, for example.

The machine-readable instructions in the storage medium 404 include file obscuring instructions 410 to obscure the file and add the obscured file to an upper filesystem layer that overlays the base filesystem layer. The obscured file added to the upper filesystem layer has the same identifier (e.g., pathname) as the original file in the base filesystem layer.

The machine-readable instructions in the storage medium 404 include file access request receipt instructions 412 to receive, from a process, a request to access a first requested file identified by a first file identifier. The request may be submitted to the interface 128 of FIG. 1, for example.

The machine-readable instructions in the storage medium 404 include file identifier presence determination instructions 414 to determine whether the first file identifier is present in the upper filesystem layer. A protected file will have a file identifier present in both the upper filesystem layer and the base filesystem layer.

The machine-readable instructions in the storage medium 404 include obscured file return instructions 416 to, based on determining that the first file identifier is present in the upper filesystem layer, return an obscured version of the first requested file from the upper filesystem layer to the process.

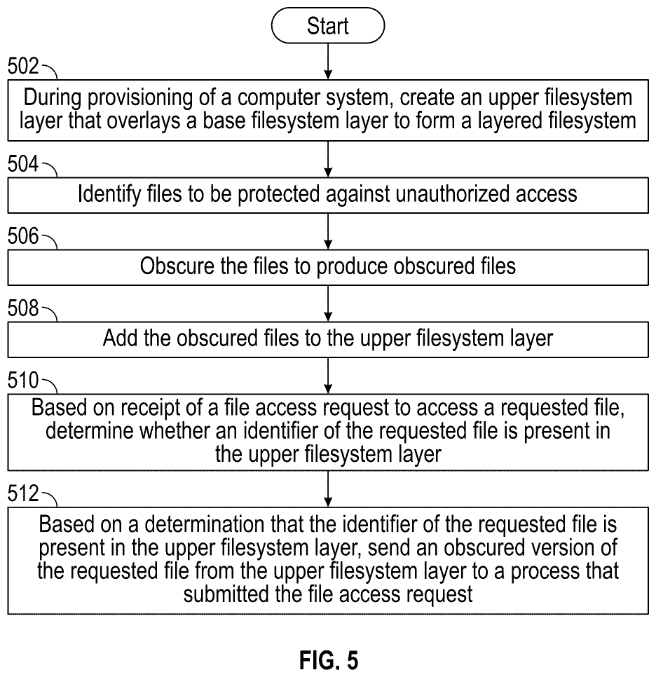

FIG. 5 is a flow diagram of a flow according to some examples of the present disclosure. The flow may be performed in the computer system 100 of FIG. 1, for example.

During provisioning of a computer system, the upper filesystem layer creation module 114 creates (at 502) an upper filesystem layer that overlays a base filesystem layer to form a layered filesystem. The upper filesystem layer creation module 114 may be part of the data protection engine 112 invoked during the provisioning.

The data protection engine 112 identifies (at 504) files to be protected against unauthorized access. The files may be identified in configuration information listing which files are to be protected.

The obscuring module 116 of the data protection engine 112 obscures (at 506) the files to produce obscured files. Obscuring the files can include anonymizing or pseudonymizing the files, for example. The data protection engine 112 adds (at 508) the obscured files to the upper filesystem layer.

Based on receipt of a file access request to access a requested file, the overlay filesystem driver 120 determines (at 510) whether an identifier of the requested file is present in the upper filesystem layer. Based on a determination that the identifier of the requested file is present in the upper filesystem layer, the overlay filesystem driver 120 sends (at 512) an obscured version of the requested file from the upper filesystem layer to a process that submitted the file access request.

As used here, an “engine” (e.g., the data protection engine 112 of FIG. 1) can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A “module” (e.g., the upper filesystem layer creation module 114 and the obscuring module 116) in an engine can be implemented with a portion of the hardware processing circuitry of the engine, or with machine-readable instructions executable by the engine.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a computer system to:
store, by a base filesystem layer, a file;
as part of provisioning the computer system:
create an upper filesystem layer that overlays the base filesystem layer,
obscure the file to render at least a portion of the file inaccessible, and
add the obscured file to the upper filesystem layer; and
responsive to an access request from a process targeting the file, return, from the upper filesystem layer, the obscured file to the process.

2. The non-transitory machine-readable storage medium of claim 1, wherein the file in the base filesystem layer is inaccessible to the process.

3. The non-transitory machine-readable storage medium of claim 1, wherein the file is part of a plurality of files stored by the base filesystem layer, wherein the instructions upon execution cause the computer system to:
obscure the plurality of files; and
add the obscured plurality of files to the upper filesystem layer,
the obscured plurality of files accessible to the process.

4. The non-transitory machine-readable storage medium of claim 1, wherein the access request comprises a system call from the process.

5. The non-transitory machine-readable storage medium of claim 1, wherein the access request is received through a /proc interface or a /sys interface.

6. The non-transitory machine-readable storage medium of claim 1, wherein the base filesystem layer and the upper filesystem layer form a layered filesystem, and wherein an identifier of the file is present in both the base filesystem layer and the upper filesystem layer.

7. The non-transitory machine-readable storage medium of claim 6, wherein the instructions upon execution cause the computer system to:
when starting the process in the computer system, configure the process to use the layered filesystem.

8. The non-transitory machine-readable storage medium of claim 7, wherein the file present in the base filesystem layer is hidden from the process.

9. The non-transitory machine-readable storage medium of claim 1, wherein the process is executed at a virtual compute entity in the computer system.

10. The non-transitory machine-readable storage medium of claim 1, wherein the process is a user space process.

11. The non-transitory machine-readable storage medium of claim 1, wherein obscuring the file comprises anonymizing or pseudonymizing the file.

12. The non-transitory machine-readable storage medium of claim 1, wherein obscuring the file comprises encrypting the file or replacing the file with a shell file.

13. The non-transitory machine-readable storage medium of claim 1, wherein the file comprises a plurality of portions, and wherein the obscuring of the file comprises obscuring a first portion of the file without obscuring a second portion of the file.

14. The non-transitory machine-readable storage medium of claim 1, wherein the provisioning of the computer system comprises initially setting up the computer system or updating a configuration of the computer system.

15. A computer system comprising:
a hardware processor; and
a non-transitory storage medium storing instructions executable on the hardware processor to:
identify a file, in a base filesystem layer, to be protected from unauthorized access;
retrieve the file from the base filesystem layer;
obscure the file and add the obscured file to an upper filesystem layer that overlays the base filesystem layer;
receive, from a process, a request to access a first requested file identified by a first file identifier;
determine whether the first file identifier is present in the upper filesystem layer; and
based on determining that the first file identifier is present in the upper filesystem layer, return an obscured version of the first requested file from the upper filesystem layer to the process.

16. The computer system of claim 15, wherein the instructions are executable on the hardware processor to:
receive, from the process or a further process, a request to access a second requested file identified by a second file identifier;
determine whether the second file identifier is present in the upper filesystem layer; and
based on determining that the second file identifier is not present in the upper filesystem layer, access the second requested file from the base filesystem layer and return the second requested file to the process or the further process.

17. The computer system of claim 15, wherein the instructions are executable on the hardware processor to:
create the upper filesystem layer during provisioning of the computer system.

18. The computer system of claim 15, wherein obscuring the file comprises anonymizing or pseudonymizing the file.

19. A method comprising:
during provisioning of a computer system, creating an upper filesystem layer that overlays a base filesystem layer to form a layered filesystem;
identifying files to be protected against unauthorized access;
obscuring, by the computer system, the files to produce obscured files;
adding the obscured files to the upper filesystem layer;
based on receipt of a file access request to access a requested file, determining, by the computer system, whether an identifier of the requested file is present in the upper filesystem layer; and
based on a determination that the identifier of the requested file is present in the upper filesystem layer, sending, by the computer system, an obscured version of the requested file from the upper filesystem layer to a process that submitted the file access request.

20. The method of claim 19, wherein the identifier of the requested file is also present in the base filesystem layer, and wherein the requested file in the base filesystem layer is hidden from the process.
